(19) United States
(12) Patent Application Publication
(10) Pub. No.: US 2009/0172710 A1
(43) Pub. Date: Jul. 2, 2009

(54) METHOD AND SYSTEM FOR ENABLING A MINI PROGRAM ON A COMPUTING DEVICE TO ACCESS AN AUXILIARY SYSTEM

(76) Inventors: Arman Toorians, San Jose, CA (US); Chong-Li Liu, Sanchong City (TW)

Correspondence Address: PATTERSON & SHERIDAN, L.L.P., 3040 POST OAK BOULEVARD, SUITE 1500, HOUSTON, TX, 77056, US

(21) Appl. No.: 11/966,717

(22) Filed: Dec. 28, 2007

(51) Int. Cl. G06F 9/44

(52) U.S. Cl. 719/328

(57) ABSTRACT

A method and system for enabling a mini program on a computing device to access an auxiliary system are disclosed. Specifically, one embodiment of the present invention is implemented on a computer system, which includes an auxiliary system configured to drive an auxiliary display and a computing device that is configured with a pre-configured software interface to enable a mini program written in a descriptive module language to access the auxiliary system. The pre-configured software interface converts the descriptive module language to a set of functions supported by an Application Programming Interface (API) specifically written in an imperative programming language for the auxiliary system.

### BACKGROUND OF THE INVENTION

1. Field of the Invention

The present invention relates to a Windows SideShow technology, and more particularly, to a method and system for providing an auxiliary system with additional functionality.

2. Description of the Related Art

Unless otherwise indicated herein, the approaches described in this section are not prior art to the claims in this application and are not admitted to be prior art by inclusion in this section.

With Windows Vista operating systems becoming the dominant operating systems for personal computers, a variety of software or hardware applications compatible with Vista-based computer systems are also becoming more and more popular. One of the Vista-based software/hardware applications is Windows SideShow, which is a technology that supports an auxiliary screen to the Vista-based computer system.

The SideShow technology is to employ SideShow gadgets, which are mini programs, on the Windows Vista-based computing device to establish the communication between the computing device and an auxiliary system (e.g., a SideShow device). Various useful tools such as Yahoo widgets or Google gadgets powered by Yahoo engines or Google engine, respectively, offer mature network communication and multimedia functions. These tools generally are performed on the computing device only and cannot communicate with the SideShow device, because they were initially developed without considering the SideShow Application Programming Interface (API). To rewrite these widgets or gadgets to communicate with the SideShow device is currently a difficult process. In particular, since developers of the tools or the engines that support the tools are not familiar with the SideShow API, rewriting the widgets or gadgets to incorporate such an API is not only time-consuming but is also prone to creating faulty software. More importantly, the developers end up wasting much time learning about and implementing the SideShow API as opposed to focusing on creating feature-rich widgets or gadgets.

To illustrate, FIG. 1 is a simplified block diagram illustrating a conventional computer system 100. The computer system 100 includes a computing device 102 and a SideShow device 104 connected to the computing device 102 with a data bus 106. The data bus 106 generally supports Bluetooth or Universal Serial Bus (USB) communication protocol. The computing device 102 is further configured with a Google gadget 108 driven by a Google engine 110, a Yahoo widget 112 driven by a Yahoo engine 114, a SideShow gadget 116, a SideShow API 118, and a SideShow driver 120. The SideShow driver 120 is mainly responsible for managing the communication between the computing device 102 and the SideShow device 104.

The Google gadget 108 and the Yahoo widget 112 are generally programmed in a descriptive module language such as Java script or extensible markup language (XML). The Google gadget 108 or the Yahoo widget 112 are interpreted and executed by the Google engine 110 or the Yahoo engine 114, respectively, and the execution results are shown on the display driven by the computing device 102. On the other hand, the SideShow gadget 116 is typically programmed in a general-purpose and imperative computer programming language, such as C/C++. As well known in the art, imperative programs are a sequence of commands for a computer to perform and essentially define “how” the computation is to take place. Such programs also generally need to be compiled and linked before they can be executed. The SideShow gadget 116 communicates with both the SideShow device 104 and also its corresponding application programs (not shown) that operate on the computing device 102. Unlike the Google gadget 108 and the Yahoo widget 112, the SideShow gadget 116 relies on the application programs to help carry out its supported functions and causes the execution results to be shown on the auxiliary display of the SideShow device 104. To summarize, to have the Google gadget 108 or the Yahoo widget 112 access the SideShow device 104, these tools need to be rewritten to incorporate the SideShow API 118. To impose such a difficult rewriting task on the developers of gadgets and widgets is likely to introduce undesirable delays and errors, because these tool developers will necessarily need to spend significant amount of time to learn a different programming language (e.g., the imperative programming language) and a new API (e.g., the SideShow API 118).

What is needed in the art is thus a method and system for abstracting the details of the SideShow API from the developers of the Google gadgets or the Yahoo widgets, so that the Google gadgets or the Yahoo widgets can still be efficiently written to access a SideShow device and address at least the problems set forth above.

### SUMMARY OF THE INVENTION

A method and system for enabling a mini program on a computing device to access an auxiliary system are disclosed. Specifically, one embodiment of the present invention is implemented on a computer system, which includes an auxiliary system configured to drive an auxiliary display and a computing device that is configured with a pre-configured software interface to enable a mini program written in a descriptive module language to access the auxiliary system. The pre-configured software interface converts the descriptive module language to a set of functions supported by an Application Programming Interface (API) specifically written in an imperative programming language for the auxiliary system.

At least one advantage of the present invention disclosed herein is to eliminate the need to completely rewrite existing Yahoo widgets or Google gadgets in a language that is recognized and supported by the SideShow API and thus saving the time and efforts to develop such a mini program to access a SideShow device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the drawings. It is to be noted, however, that the drawings illustrate only typical embodiments of this invention and are therefore not to be considered limiting of its scope, for the invention may admit to other equally effective embodiments.

FIG. 1 is a simplified block diagram illustrating a conventional computer system 100;

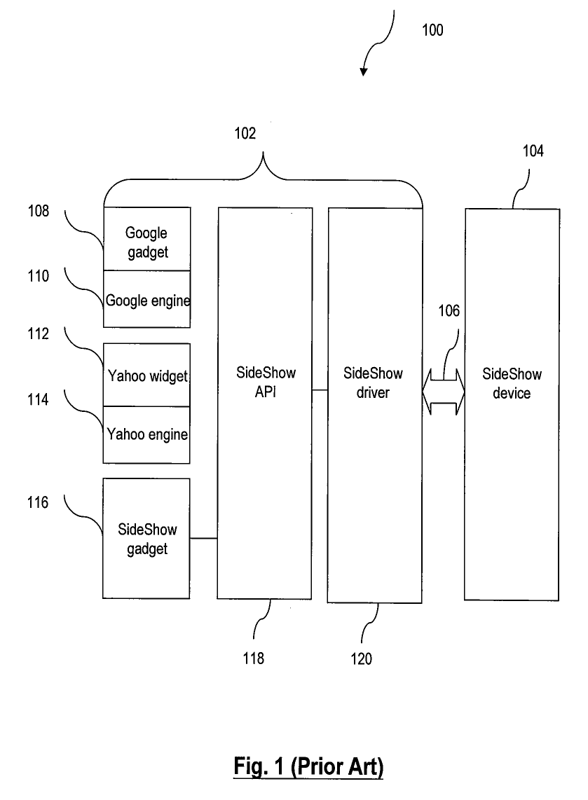

FIG. 2 is a simplified block diagram illustrating various software components on a computer system 200, according to one embodiment of the present invention;

FIG. 3 is a schematic diagram illustrating how a pre-configured software interface operates according to one embodiment of the present invention; and

FIG. 4 is a simplified block diagram illustrating a computer system 400, according to one embodiment of the present invention;

### DETAILED DESCRIPTION

Throughout this description, a computer system may include a main system and an auxiliary system. The main system typically is configured with a feature-rich operating system, such as Windows Vista, and much computing resources, such as central processing units (CPUs) and memory systems. The auxiliary system, on the other hand, is typically configured with embedded software programs and limited hardware resources. A “primary display” broadly refers to the display mainly driven by the main system, and an “auxiliary display” broadly refers to the display that can be driven by either the main system or the auxiliary system. Here, an example of the main system is a laptop computer, and an example of the auxiliary system is a SideShow device coupled to the laptop computer. In addition, a Google gadget or a Yahoo widget is generally referred to as a mini program that is interpreted and executed by its respective Google engine or Yahoo engine. The engine typically employs a runtime environment combined with an interpreter to run the mini program.

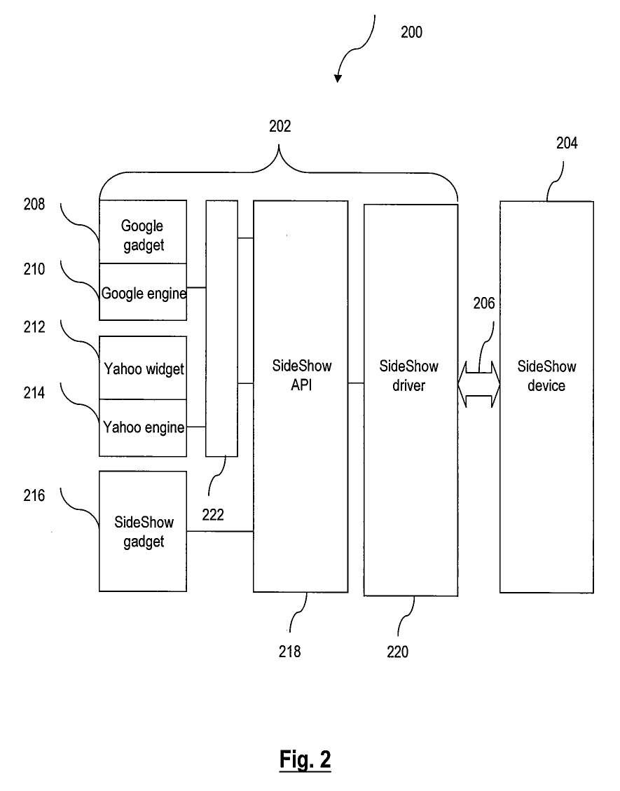

FIG. 2 is a simplified block diagram illustrating the various software components on a computer system 200, according to one embodiment of the present invention. The computer system 200 includes a computing device 202 and a SideShow device 204 connected to the computing device 202 with a data bus 206. The data bus 206 generally is of a Bluetooth or Universal Serial Bus (USB) communication protocol. The computing device 202 includes a Google gadget 208 driven by a Google engine 210, a Yahoo gadget 212 driven by a Yahoo engine 214, a SideShow gadget 216, a SideShow API 218, a SideShow driver 220, and a pre-configured software interface 222. The SideShow driver 220 is responsible for the data communication between the computing device 202 and the SideShow device 204. The pre-configured software interface 222 is configured to interpret the functions provided by the Google gadget 208 or the Yahoo widget 212 to those recognized and supported by the SideShow API 218.

The pre-configured software interface 222 is also configured to relay “SideShow events” from the SideShow device 204. The events could be commands or responses from the SideShow device 204. Those events are transferred from the SideShow device 204 to the SideShow driver 220 through the data bus 206, the SideShow API 218, and the preconfigured software interface 222. Upon the receipt of the events, the pre-configured software interface 222 notifies the Google gadget 208 or the Yahoo widget 212 of the same and has them transferred to the Google gadget 208 or the Yahoo widget 212. Thereafter, the events will be further processed by the Google engine 210 or the Yahoo engine 214.

Pre-configuring the software interface is to provide the developers of the Yahoo widgets or the Google gadgets with an extra set of instructions in the form of the descriptive computer languages such as XML or Java-script at the time of the programming of the Yahoo widgets or the Google gadgets. Ideally, the developers are to get how many extra instructions (in addition to those recognized by the Google/Yahoo engines) they will be going to have before programming the Yahoo widgets or the Google gadgets. Each extra instruction in the XML or Java-script provided by the pre-configured software interface corresponds to instructions supported and recognized by the SideShow API. Those extra instructions in the descriptive computer languages and their counterparts supported and recognized by the SideShow API are stored in the computing device. Thereby, the pre-configured software interface is capable of looking up the extra instructions in the descriptive languages stored in the computing device and then to generate the corresponding instructions recognized and supported by the SideShow API accordingly. With the pre-configured software interface in place, Yahoo widget/Google gadget developers do not have to worry about whether instructions they are going to put into the Yahoo widgets or the Google gadgets would be recognized and supported by the SideShow API or not so long as they employ no instructions other than those provided by the pre-configured software interface and the Yahoo/Google engines. As such, functions provided by the Yahoo widgets/Google gadgets in the form of sequences of instructions could be performed on the SideShow device.

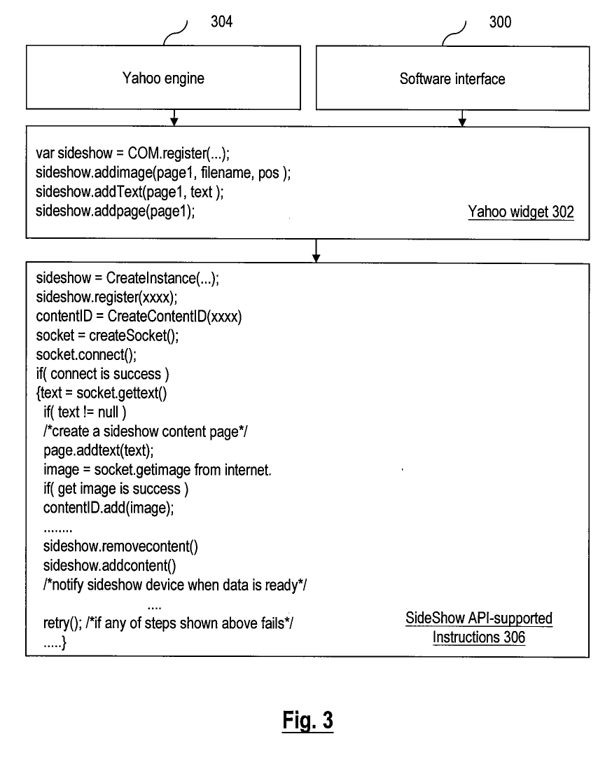

To illustrate, please refer to FIG. 3 of a schematic diagram showing how the pre-configured software interface 300 operates. The pre-configured software interface 300 is either a Common Object Model (COM) model or ActiveX-based. We take the Yahoo widget 302 along with its corresponding Yahoo engine 304 for example here while the pre-configured software interface 300 is a distinct software component with respect to the Yahoo engine 304. In one implementation of the present invention, the pre-configured software interface 300 could be part of the Yahoo engine 304. The aforementioned discussion regarding the relationship between the pre-configured software interface 300 and the Yahoo engine 304 applies the same force to that between the pre-configured software interface and the Google engine.

The pre-configured software interface 300 is launched by the Yahoo engine 304 during the initialization. The Yahoo engine is to execute according to the content of the Yahoo widget 302. The content of the Yahoo widget 302 includes instructions written in XML or Java-script. When the Yahoo engine 304 runs into instructions not recognized by itself over the course of the executing, the Yahoo engine 304 calls the pre-configured software interface 300 for help. The pre-configured software interface 300 then interprets those instructions to instructions recognized and supported by the SideShow API.

In one implementation of the present invention, assume instructions written into the Yahoo widget 302 in FIG. 3 are all SideShow-related. As the result, the Yahoo engine 304 might not be able to execute according to the SideShow-related instructions in the Yahoo widget 302 and then the pre-configured software interface 300 will be called to interpret those SideShow-related instructions not recognized by the Yahoo engine 304. Instructions in the Yahoo widget 302 will be turned into the SideShow API-supported instructions shown in 306. The pre-configured software interface 300 is configured to interpret each line of the instructions of the Yahoo widget 302 to at least one line of instruction supported by SideShow API in 306. As the result, those SideShow API-supported instructions converted from the instructions in XML or Java-script in the Yahoo widget 302 could be performed on the SideShow device.

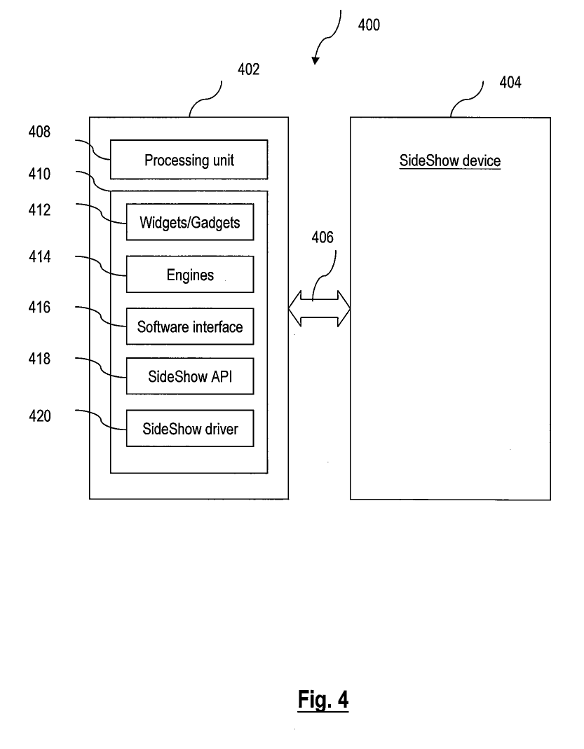

FIG. 4 is a simplified block diagram illustrating a computer system 400 according to one embodiment of the present invention. The computer system 400 includes a computing device 402 and a SideShow device 404 as an auxiliary system connected to the computing device 402 through a data bus 406. The computing device 402 includes a processing unit 408 and a memory unit 410. The memory unit 410 stores Yahoo widgets/Google gadgets 412, corresponding Yahoo/Google engines 414, corresponding pre-configured software interfaces 416, a SideShow API 418, and a SideShow driver 420.

The Yahoo widgets/Google gadgets 412 are computer-readable files written in descriptive computer languages such as XML or Java-script while the Yahoo/Google engines 414 are application programs for executing according to the content of the Yahoo widgets/Google gadgets 412 on the computing device 402. The Yahoo/Google engines are also configured to display the result of the executing on the display of the computing device 402. The pre-configured software interfaces 416 are configured to interpret the instructions in the Yahoo widgets/Google gadgets 412 not recognized by the Yahoo/Google engines 414 to the instructions recognized and supported by the SideShow API 418, which communicates with the SideShow driver 420 in order to facilitate the communication with the SideShow device 402. Absent the pre-configured software interface 416, SideShow-related instructions are not to be recognized or executed by the Yahoo/Google engines and thus the functions represented by those SideShow-related instructions cannot be performed on the SideShow device 402.

The Yahoo/Google engines 414 are configured to launch the pre-configured software interfaces 416. The launched pre-configured software interfaces 416 await calls from the Yahoo/Google engines 414 in the event of any instruction the latter cannot recognize (e.g., Side-Show-related instructions) during the course of executing on the basis of the content of the Yahoo widgets/Google gadgets 412. Then the pre-configured software interfaces 416 interpret each of those instructions to its corresponding SideShow API-recognized instruction(s). After the interpretation, instructions written in the descriptive computer languages have been turned to instructions supported by the SideShow API. As the result, functions in the form of those interpreted instructions are to be performed on the SideShow device 404 without difficulty.

It is worth noting that the number of the types of the interpretable instructions written in the descriptive computer languages is predetermined by programmers of the software interfaces 416. In other words, if the developers of the Yahoo widgets/Google gadgets 412 write instructions not covered by their corresponding pre-configured software interfaces 416 they are not going to be interpreted at all.

As has been demonstrated, functions provided by the Yahoo widgets/Google gadgets can be performed on the SideShow device as an auxiliary system at the present even they are written in descriptive computer languages not supported by the SideShow API. With the pre-configured software interfaces interpreting instructions written in the descriptive computer languages not recognized by the Yahoo/Google engines to instructions supported and recognized by the SideShow API, functions implemented by those instructions will be performed on the SideShow device.

The above description illustrates various embodiments of the present invention along with examples of how aspects of the present invention may be implemented. One embodiment of the present invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips, or any type of solid-state non-volatile semiconductor memory) on which information is permanently stored; and (ii) writable storage media (e.g., floppy disks within a diskette drive, CD-RW disks, DVD-RW disks, flash memory, hard-disk drive, or any type of solid-state random-access semiconductor memory) on which alterable information is stored. The above examples, embodiments, instruction semantics, and drawings should not be deemed to be the only embodiments, and are presented to illustrate the flexibility and advantages of the present invention as defined by the following claims.

We claim:

1. A computer system, comprising:
an auxiliary system configured to drive an auxiliary display; and
a computing device configured with a pre-configured software interface that enables a mini program written in a descriptive module language to access the auxiliary system, wherein the pre-configured software interface converts the descriptive module language to a set of functions supported by an Application Programming Interface (API) specifically written in an imperative programming language for the auxiliary system.

2. The computer system of claim 1, wherein the descriptive module language is an extensible markup language (XML).

3. The computer system of claim 1, wherein the computing device is further configured with an application program to interpret the content of the mini program, carry out functions specified in the mini program, and communicate with the pre-configured software interface if any of the functions is associated with the auxiliary system.

4. The computer system of claim 3, wherein if the pre-configured software interface receives data intended for the computing device from the auxiliary system, then the pre-configured software interface relays the data to the mini program via the application program.

5. The computer system of claim 3, wherein the pre-configured software interface is a software component independent from the application program.

6. The computer system of claim 3, wherein the pre-configured software interface is incorporated as a part of the application program.

7. The computer system of claim 1, wherein the pre-configured software interface is written as a Common Object Model (COM) object.

8. The computer system of claim 1, wherein the pre-configured software interface is ActiveX-based.

9. The computer system of claim 1, wherein the auxiliary system is a SideShow device.

10. A computer-readable medium containing a sequence of instructions, which when executed by a processing unit of a computing device, causes the processing unit to:
launch a pre-configured software interface that enables a mini program written in a descriptive module language to access an auxiliary system coupled to the computing device, wherein the pre-configured software interface converts the descriptive module language to a set of functions supported by an Application Programming Interface (API) specifically written in an imperative programming language for the auxiliary system.

11. The computer-readable medium of claim 9, wherein the descriptive module language is an extensible markup language (XML).

12. The computer-readable medium of claim 9, further comprising a sequence of instructions for an application program, which when executed by the processing unit, causes the processing unit to interpret the content of the mini program, carry out functions specified in the mini program, and communicate with the pre-configured software interface if any of the functions is associated with the auxiliary system.

13. The computer-readable medium of claim 12, further comprising a sequence of instructions for the pre-configured software interface, which when executed by the processing unit, causes the processing unit to relay data intended for the computing device from the auxiliary system and received by the pre-configured software interface to the mini program via the application program.

14. The computer-readable medium of claim 9, wherein the pre-configured software interface is a software component independent from the application program.

15. The computer-readable medium of claim 9, wherein the pre-configured software interface is incorporated as a part of the application program.

16. The computer-readable medium of claim 9, wherein the pre-configured software interface is written as a Common Object Model (COM) object.

17. The computer-readable medium of claim 9, wherein the pre-configured software interface is ActiveX-based.

18. The computer-readable medium of claim 9, wherein the auxiliary system is a SideShow device.

19. A method for enabling a mini program on a computing device to access an auxiliary system, the method comprises:
configuring the computing device with a pre-configured software interface,
wherein the pre-configured software interface converts the mini program written in a descriptive module language to a set of functions supported by an Application Programming Interface (API) specifically written in an imperative programming language for the auxiliary system; and
interpreting the content of the mini program, carrying out functions specified in the mini program, and communicating with the pre-configured software interface if any of the functions is associated with the auxiliary system.

20. The method of claim 19, further comprising relaying data intended for the computing device from the auxiliary system and received by the pre-configured software interface to the mini program via the application program.
